(19) United States
(12) Patent Application Publication
(10) Pub. No.: US 2020/0404899 A1
(43) Pub. Date: Dec. 31, 2020

(54) INSECT CAPTURING SHEET AND INSECT CAPTURING TOOL USING THE SAME

(71) Applicant: Car-boy Co.,Ltd., Chiba (JP)

(72) Inventor: Kazuo MAWARIMOTO, Chiba (JP)

(21) Appl. No.: 17/017,773

(22) Filed: Sep. 11, 2020

Related U.S. Application Data
(63) Continuation of application No. PCT/JP2019/009635, filed on Mar. 11, 2019.

(30) Foreign Application Priority Data
Mar. 14, 2018 (JP) 2018-046421

(51) Int. Cl. A01M 3/02

(52) U.S. Cl. CPC A01M 3/022

(57) ABSTRACT

A sheet includes a flexible sheet body-having an adhesive surface, an adhesive layer on the adhesive surface of the sheet body, a net on the adhesive layer, and a release liner covering the adhesive layer including the net. When the adhesive surface of the sheet body comes in contact with a floor or wall, the net reduces direct contact between the adhesive layer and the floor or wall, thus preventing the sheet body capturing an insect pest from firmly adhering to the floor. Also, no adhesive remains on the floor as a stain.

### CROSS-REFERENCE TO RELATED APPLICATIONS

This application is a continuation application of International Patent Application No. PCT/JP2019/009635 filed on Mar. 11, 2019, which claims priority to Japanese Patent Application No. 2018-046421 filed on Mar. 14, 2018, the entire contents of which are incorporated by reference.

### BACKGROUND OF INVENTION

### Field of the Invention

The present invention relates to an insect capturing sheet for capturing insect pests infesting a house such as cockroaches and centipedes by adhesion, and to an insect capturing tool using the insect capturing sheet.

### Background Art

Insect pests infesting ordinary houses typically include German cockroaches and smokybrown cockroaches. Many other insects, such as centipedes, millipedes, moths, pentatomids, and geckos, are now increasingly infesting houses as global warming and other problems increase. In the near future, highly venomous insect pests, such as hornets, redback spiders, and red imported fire ants, may also infest houses and cause damage.

Once such insect pests are found, they are typically exterminated by applying a spray insecticide or by smashing with a fly swatter. However, spray insecticides are not fast-acting and may allow an insect pest to quickly move to behind a closet or into a narrow space between pieces of furniture, failing to provide satisfactory effects. Smashing with a fly swatter may allow an insect pest to escape when the smashing is weak, or may crush the body of the insect when the smashing is strong, thus scattering the body fluid or parts around. This is unpleasant as well as troublesome to clean up the site stained with the fluid and to dispose of the insect remains.

The inventor has developed a new insect capturing tool such as one described in Patent Literature 1. This insect capturing tool includes a plate and a pressing member attached to an end of a handle with a length of about 30 cm. A flexible insect capturing sheet having an adhesive surface is attached between the plate and the pressing member. To capture an insect pest such as a cockroach with the capturing tool, the user grips the handle with one hand, peels a release liner from the adhesive surface on the insect capturing sheet, places the adhesive surface over the cockroach as with a fly swatter, and captures the cockroach on the insect capturing sheet by adhesion.

With the cockroach being captured on the adhesive surface, the insect capturing sheet may be folded into two to wrap the cockroach inside, just like a Japanese Kashiwamochi sweet wrapped in a Kashiwa leaf, by, for example, pressing a distal portion of a non-adhesive surface on the insect capturing sheet against the floor surface. The cockroach in this state, together with the insect capturing sheet, can then be discarded into a garbage bin and can be disposed of smoothly.

When missing a target and failing to capture an insect pest with the insect capturing tool described in Patent Literature 1, the capturing sheet can entirely adhere to the floor or wall and cannot be peeled off easily. When successfully capturing the insect pest, the capturing sheet can partially adhere to the floor or wall except where the insect pest is captured, and cannot be peeled off easily. To reduce adhesion to the floor or wall, the capturing sheet may have a wavy cross section or may have the adhesive surface with protrusions in a mesh pattern or embossed, thus reducing the area of contact with a flat floor or other flat surfaces.

### CITATION LIST

### Patent Literature

Patent Literature 1: Japanese Registered Utility Model No. 3006115

### SUMMARY OF INVENTION

### Technical Problem

To reliably capture a fast-moving insect pest, the capturing sheet may use a highly-adhesive material as an adhesive. In this case, the adhesive surface can firmly adhere to the floor or wall and cannot be peeled off easily, although the capturing sheet is in point or line contact with the floor or wall as with the known technique. Also, the capturing sheet in point or line contact with the floor or wall may leave the adhesive partially on the floor or wall as a stain.

In response to the above issue, one or more aspects of the present invention are directed to a novel insect-capturing sheet including a sheet body that avoids firmly adhering to the floor or wall in capturing an insect pest and to an insect capturing tool using the insect capturing sheet.

### Solution to Problem

An insect capturing sheet according to a first aspect of the present invention includes a flexible sheet body having an adhesive surface, an adhesive layer on the adhesive surface of the sheet body, a net on the adhesive layer, and a release liner entirely covering the adhesive layer including the net. With the above structure, when the adhesive surface of the sheet body comes in contact with a floor or wall, the net reduces direct contact between the adhesive layer and the floor or wall, thus preventing the sheet body capturing an insect pest from firmly adhering to the floor or wall. Also, no adhesive remains on the floor or wall as a stain. The adhesive layer has a portion uncovered with the net to come in contact with the insect pest on the floor or wall, thus reliably capturing the insect pest by adhesion.

An insect capturing sheet according to a second aspect of the present invention includes a flexible sheet body having an adhesive surface, a plurality of protrusions on the adhesive surface of the sheet body, an adhesive layer on substantially an entirety of the adhesive surface excluding portions where the plurality of protrusions are arranged, and a release liner entirely covering the adhesive layer. With the above structure, when the adhesive surface of the flexible sheet comes in contact with the floor or wall, the protrusions having no adhesive component come in contact with the floor or wall, thus preventing the sheet body capturing an insect pest from firmly adhering to the floor or wall. In the same manner as in the first aspect, no adhesive remains on the floor or wall as a stain. The adhesive layer has a portion without the protrusions to come in contact with the insect pest on the floor or wall, thus reliably capturing the insect pest by adhesion.

An insect capturing sheet according to a third aspect of the present invention is the insect capturing sheet according to the first or second aspect in which the sheet body includes a crease along which the sheet body is foldable to have the adhesive surface inside. With the above structure, after capturing an insect pest, the sheet body can be easily folded in two along the crease. The captured insect pest is thus wrapped and disposed of smoothly.

An insect capturing sheet according to a fourth aspect of the present invention is the insect capturing sheet according to any one of the first to third aspects in which the sheet body has an end face including an end adhesive layer. With the above structure, when the sheet body is folded in two to wrap the captured insect pest for disposal, the end adhesive layer is placed into contact with a floor or another surface to have the end adhesive layer loosely adhering to the floor. This allows easy and reliable wrapping of the insect pest with the adhesive surface of the sheet body.

An insect capturing tool according to a fifth aspect of the present invention holds one of the insect capturing sheets described above. The insect capturing tool includes a holding plate to be on a back surface of the insect capturing sheet opposite to the adhesive surface, a clamp that holds the insect capturing sheet on the holding plate, and a grip extending from the holding plate. With the above structure, the user can grip the grip after setting the insect capturing sheet to the holding plate with the clamp, place the insect capturing sheet over an insect pest as with a fly swatter, capture the insect pest with the sheet easily by adhesion, and smoothly dispose of the captured insect pest.

### Advantageous Effects

The above aspects of the present invention provide the advantageous effects described below.

1. When the adhesive surface of the sheet body comes in contact with a floor or wall, the net reduces direct contact between the adhesive layer and the floor or wall, thus preventing the sheet body capturing an insect pest from firmly adhering to the floor or wall.

2. With no adhesive component on the protrusions to be in contact with a floor or another surface, the sheet body capturing an insect pest can avoid firmly adhering to a floor or wall.

3. No adhesive remains on the floor or another surface as a stain.

4. After capturing an insect pest, the sheet body can be easily folded in two along the crease. The captured insect pest is thus wrapped and disposed of smoothly.

5. When the sheet body is folded in two to wrap the captured insect pest for disposal, the end adhesive layer is placed into contact with a floor or another surface to have the end adhesive layer loosely adhering to the floor. This allows easy and reliable wrapping of the insect pest by the adhesive surface of the sheet body for disposal.

### BRIEF DESCRIPTION OF THE DRAWINGS

FIG. 1 is a front surface view of an insect capturing sheet 100 according to one embodiment of the present invention.

FIG. 2 is a back surface view of the insect capturing sheet 100 according to the embodiment of the present invention.

FIG. 3 is a cross-sectional view taken along line A-A in FIG. 1.

FIG. 4 is a front view in direction A in FIG. 3.

FIG. 5 is a perspective view of an insect capturing tool 20 according to another embodiment of the present invention.

FIG. 6 is a side view of the insect capturing tool 20 according to the other embodiment of the present invention.

FIG. 7 is a bottom view of the insect capturing tool 20 according to the other embodiment of the present invention.

FIG. 8 includes bottom views of the insect capturing sheet 100 and a holding plate 21 to which the insect capturing sheet 100 is attachable.

FIG. 9 is a perspective view of a clamp 22.

FIG. 10(A) is a plan view of the clamp 22, and FIG. 10(B) is a side view of the clamp 22.

FIG. 11 shows (A) a side view of the clamp 22 that is open, and (B) a side view of the clamp 22 that is closed.

FIG. 12 is a side view of a grip 23 extended in the insect capturing tool 20.

FIG. 13 is a schematic diagram describing an example use of the insect capturing tool 20 according to the other embodiment of the present invention.

FIG. 14 is a schematic diagram describing wrapping of a captured insect pest P.

FIG. 15 is a schematic diagram describing wrapping of a captured insect pest P.

FIG. 16 is a front surface view of an insect capturing sheet 100 according to another embodiment of the present invention.

FIG. 17 is a back surface view of the insect capturing sheet 100 according to the other embodiment of the present invention.

FIG. 18 is a cross-sectional view taken along line A-A in FIG. 16.

FIG. 19 is a front view in direction A in FIG. 18.

FIG. 20 is a schematic diagram describing an example manufacture of the insect capturing sheet 100 shown in FIG. 16.

### DETAILED DESCRIPTION

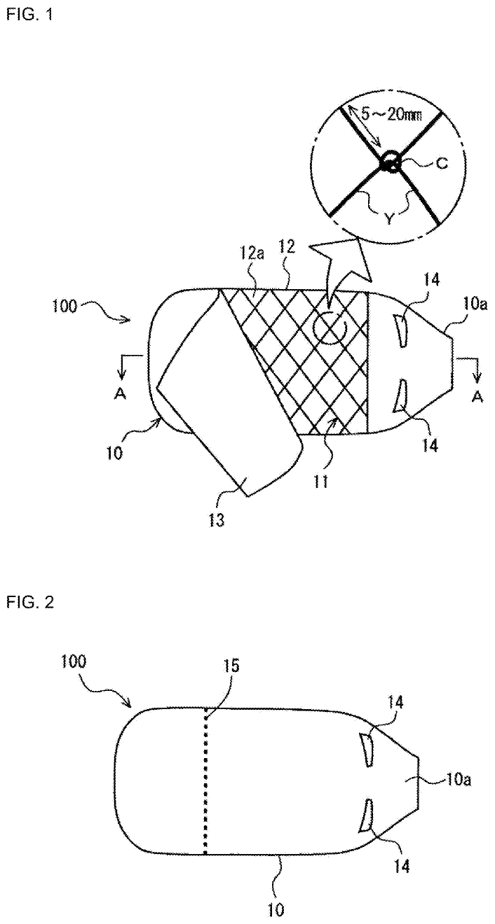

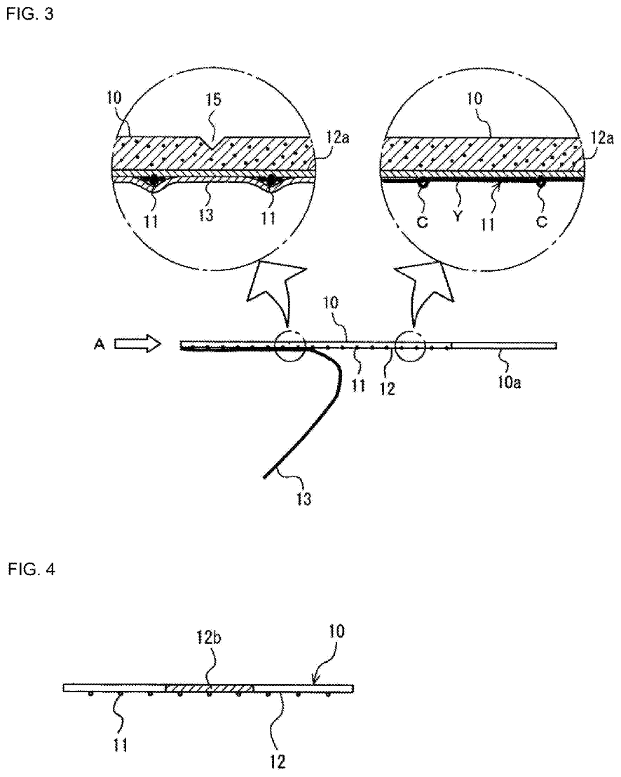

One or more embodiments of the present invention will now be described with reference to the accompanying drawings. FIGS. 1 to 4 are views of an insect capturing sheet 100 according to an embodiment of the present invention. FIG. 1 is a front surface view, FIG. 2 is a back surface view, FIG. 3 is a cross-sectional view taken along line A-A in FIG. 1, and FIG. 4 is a front view in direction A in FIG. 3. As illustrated, the insect capturing sheet 100 includes a substantially rectangular, flexible sheet body 10 having an adhesive surface (front surface) 12, an adhesive layer 12a on the adhesive surface 12 of the sheet body 10, and a net 11 on the adhesive layer 12a.

A release liner 13 is located over the net 11 to cover the adhesive layer 12a entirely. When the release liner 13 is peeled off, the adhesive layer 12a appears entirely together with the net 11. As shown in FIG. 2, the surface (back surface) opposite to the adhesive surface 12 has no adhesive layer 12a or net 11, with the surface of the sheet body 10 directly exposed.

The flexible sheet body 10 is formed from any material that is easily foldable, such as expanded polystyrene or another lightweight and flexible material. The sheet body 10 has, for example, a length of about 150 mm, a width of 100 mm, and a thickness of about 2 to 3 mm. The sheet body 10 has, on its one end (rear end), an attachment portion 10a continuous with the end. The attachment portion 10a has a pair of attachment holes 14 extending in the width direction to attach the insect capturing sheet 100 to an insect capturing tool 20 described later.

The sheet body 10 has a crease 15 extending in the width direction at a predetermined position, for example, at a position 5 to 6 cm from the distal end of the sheet body 10. The sheet body 10 is foldable in two along the crease 15 with the adhesive surface 12 inside. More specifically, the crease 15 is a V-shaped slit or a groove as shown in FIG. 3 in an enlarged manner. The adhesive surface 12 of the sheet body 10 is entirely pre-coated for surface smoothness, thus increasing the durability (hardness) of the adhesive surface 12 and the stability of the adhesive.

The adhesive layer 12a on the sheet body 10 is a known rubber adhesive or acrylic adhesive. As shown in FIG. 4, the sheet body 10 also has, substantially in the middle of its distal end face, an end adhesive layer 12b continuous with or separate from the adhesive layer 12a on the adhesive surface 12. The release liner 13 thus extends to the distal end face to cover the end adhesive layer 12b.

The net 11 includes yarns Y formed from a resin such as polypropylene (PP) having a thickness of about 0.2 mm. The yarns Y are knitted together in a lattice or in a diamond pattern. The net 11 is located over the adhesive layer 12a with a small gap between them. As shown in FIG. 1, the net 11 has a mesh size of about 5 to 20 mm, or more specifically, about 10 mm. The net 11 includes intersections C at which the yarns Y are tied together, forming knots or raised dots. The intersections in the net 11 may be knotless or Raschel knitted.

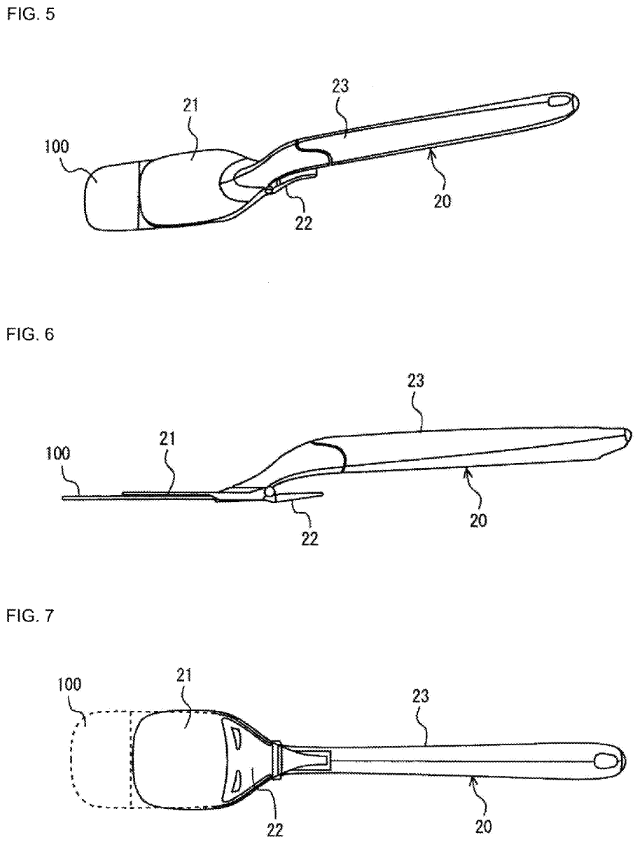

FIGS. 5 to 7 are views of the insect capturing tool 20 to which the insect capturing sheet 100 is attached when in use according to another embodiment of the present invention. FIG. 5 is a perspective view, FIG. 6 is a side view, and FIG. 7 is a bottom view.

As illustrated, the insect capturing tool 20 includes a holding plate 21 to be located on the back surface (non-adhesive surface) of the insect capturing sheet 100 described above, a clamp 22 to hold the insect capturing sheet 100 on the holding plate 21, and a grip 23 extending from the clamp 22. As shown in FIGS. 5 to 7, the holding plate 21 is a thin, spatulate plate with a distal end expanding in an oval like a rice paddle. The insect capturing sheet 100 is to be attached to the inner (bottom) surface of the holding plate 21.

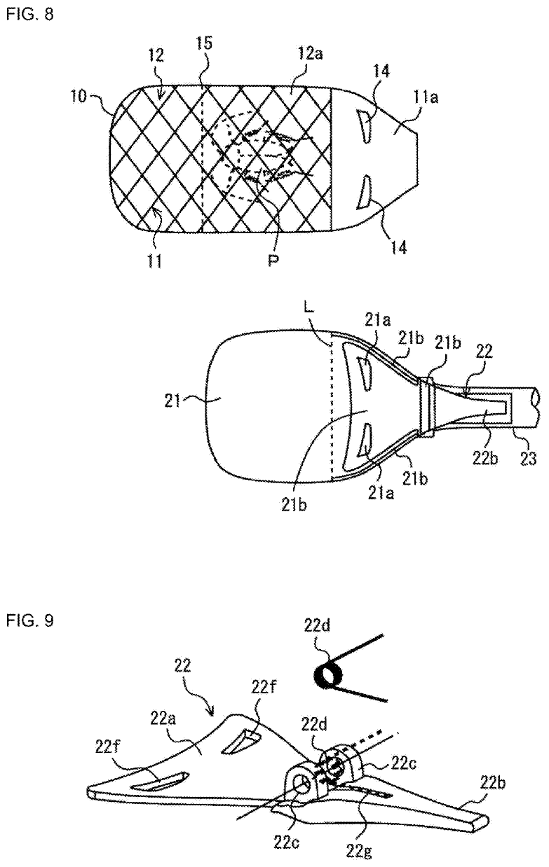

More specifically, as shown in FIG. 8, the holding plate 21 has, on its lower surface, a pair of protrusions 21a in a narrow portion at an end of the lower surface (adjacent to the grip 23). The pair of protrusions 21a correspond to the pair of attachment holes 14 in the attachment portion 10a of the sheet body 10. The holding plate 21 also has guides 21b to be aligned with the outer edge of the attachment portion 10a. The protrusions 21a are fitted in the attachment holes 14 in the sheet body 10 to attach the insect capturing sheet 100 to the lower surface of the holding plate 21 as shown in FIG. 7.

The holding plate 21 has its entire body or at least its flat distal end portion, such as a portion from a line L to the distal end shown in FIG. 8, formed from a flexible resin material, such as rubber (elastomer), polyvinyl chloride (PVC) commonly referred to as soft rubber, polyethylene, and polypropylene. The flexible holding plate 21 is thus deformable and recoverable under an appropriate force.

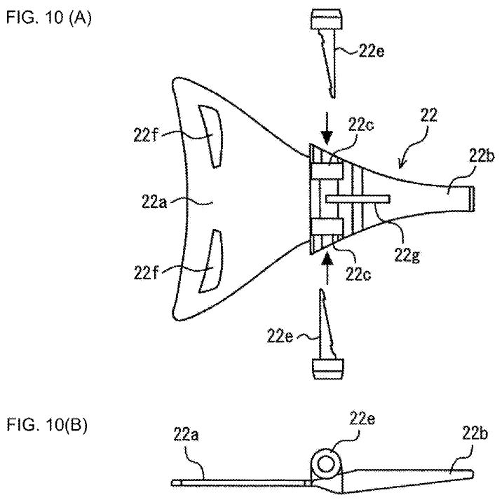

As shown in FIGS. 9 and 10, the clamp 22 includes a fan-shaped clamp body 22a, a bar-shaped handle 22b extending from the clamp body 22a, shaft holes 22c at the joint between the clamp body 22a and the handle 22b, a coil spring 22d, and divided pins 22e for connection.

As shown in FIG. 9, with the coil spring 22d having one end fitted in a spring groove 22g on the handle 22b, the shaft holes 22c are aligned coaxially with shaft holes (not shown) in the holding plate 21. As shown in FIG. 10, the divided pins 22e are placed through the shaft holes 22c through both ends of the shaft holes 22c and connected together into one piece. The clamp 22 is thus attached in a manner vertically swingable about the divided pins 22e serving as a shaft.

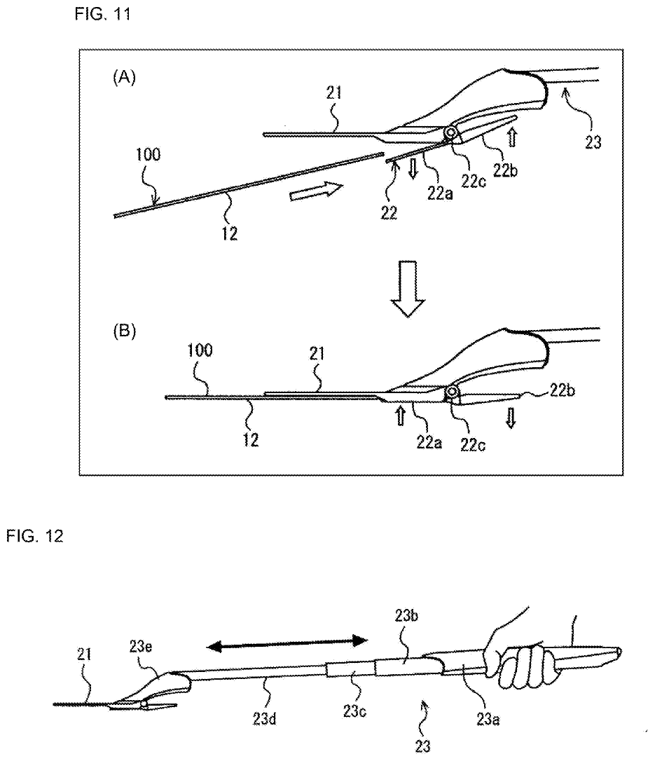

The clamp 22 attached to the holding plate 21 in the above manner has the coil spring 22d located on the shaft urging the fan-shaped clamp body 22a closely against the lower surface of the holding plate 21. As the handle 22b is moved toward the grip 23 with fingers as shown in FIG. 11, the entire clamp 22 swings to separate the clamp body 22a from the holding plate 21. When the handle 22b is released, the urging force from the coil spring 22d automatically restores the clamp body 22a to an original position.

As shown in FIGS. 9 and 10, the clamp body 22a of the clamp 22 has fitting holes 22f similar to the attachment holes 14 in the insect capturing sheet 100. When the clamp body 22a is in close contact with the lower surface of the holding plate 21, the fitting holes 22f are fitted with the protrusions 21a on the holding plate 21, without any interference between the clamp body 22a and the holding plate 21.

As shown in FIG. 12, the grip 23 includes multiple tubes arranged telescopically to one another. More specifically, the grip 23 includes a hollow grip body 23a for direct gripping by a hand as illustrated, a first inner tube 23b retractable in the grip body 23a, a second inner tube 23c retractable in the first inner tube 23b, and a third inner tube 23d retractable in the second inner tube 23c.

The third inner tube 23d has the distal end integrally connected to the holding plate 21 with a grip head 23e extending from the upper end surface of the holding plate 21. The grip body 23a, the first inner tube 23b, the second inner tube 23c, and the third inner tube 23d each have a length of, for example, about 20 cm. The grip body 23a, the first inner tube 23b, the second inner tube 23c, and the third inner tube 23d together have a maximum length of 60 to 80 cm when extended, and together have a minimum length equal to the length of the grip body 23a or specifically about 20 cm when contracted. Thus, the total length of the grip 23 can be adjusted within about 20 to 80 cm by adjusting the extensions of the first inner tube 23b, the second inner tube 23c, and the third inner tube 23d retracted in the grip body 23a.

An operation of the insect capturing tool 20 according to one or more embodiments of the present invention with the above structure will now be described. When finding an insect pest on a floor or wall of a room, a resident first raises the handle 22b of the clamp 22 as shown in FIG. 11 and sets the insect capturing sheet 100 on the lower surface of the holding plate 21 with the adhesive surface 12 facing downward. The resident then releases the handle 22b of the clamp 22, allowing the clamp 22 and the holding plate 21 to hold the insect capturing sheet 100 between them. As shown in FIG. 12, the resident may also adjust the grip 23 to an appropriate length by pulling out the first inner tube 23b or other tubes.

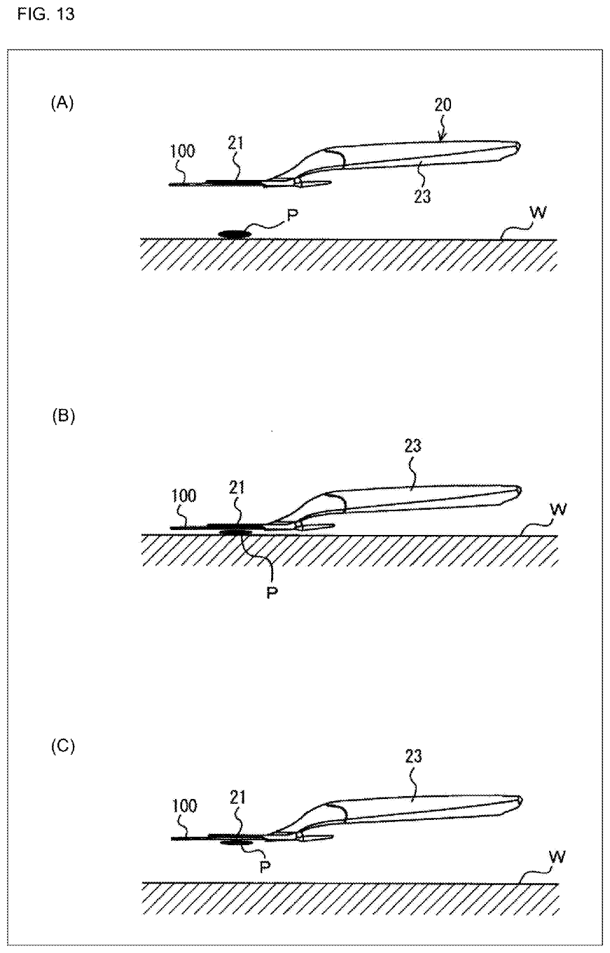

As shown in FIGS. 13(A) and 13(B), the grip body 23a of the grip 23 is then held with a hand. The insect capturing sheet 100 is placed over an insect pest P as with a fly swatter, and the holding plate 21 is quickly slammed down onto a floor or wall W. The insect pest P on the floor W then adheres to the adhesive layer 12a on the insect capturing sheet 100 almost immovably and is thus captured. In the figures, the grip 23 is at a minimum length for ease of illustration.

The grip 23, which includes multiple tubes arranged telescopically as described above, may be extended as appropriate to allow the insect capturing sheet 100 to readily access areas that are difficult to reach, such as ceilings and spaces behind objects. An insect pest P in such areas may be easily captured.

After capturing the insect pest P on the insect capturing sheet 100 in the above manner, the insect capturing sheet 100 may be separated from the floor W as shown in FIG. 13(C). The insect pest P adhering to the adhesive surface 12 of the insect capturing sheet 100 is thus captured. Although a portion of the adhesive surface 12 around the captured insect pest P comes in contact with the floor W, the net 11 on the adhesive layer 12a on the adhesive surface 12 as described above prevents the insect capturing sheet 100 from clinging to the floor W or another surface or the adhesive on the adhesive layer 12a from remaining on the floor W or another surface as a stain.

When failing to capture an insect pest P as well, the insect capturing sheet 100 can avoid having the adhesive surface 12 clinging to the floor W or another surface and can be peeled off easily. With the net 11 including knots as described above, the knots alone are in point contact with the floor W. Thus, the adhesive layer 12a can avoid contact with the floor W or reduce the area of contact with the floor W. The adhesive layer 12a has the portion uncovered with the net 11 to come in contact with the insect pest P on the floor or wall W, thus reliably capturing the insect pest P by adhesion.

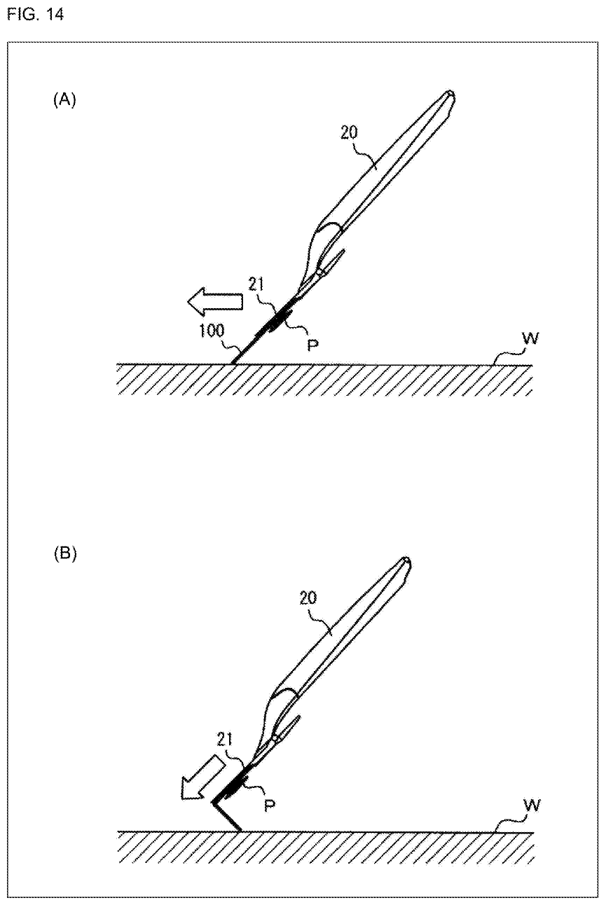

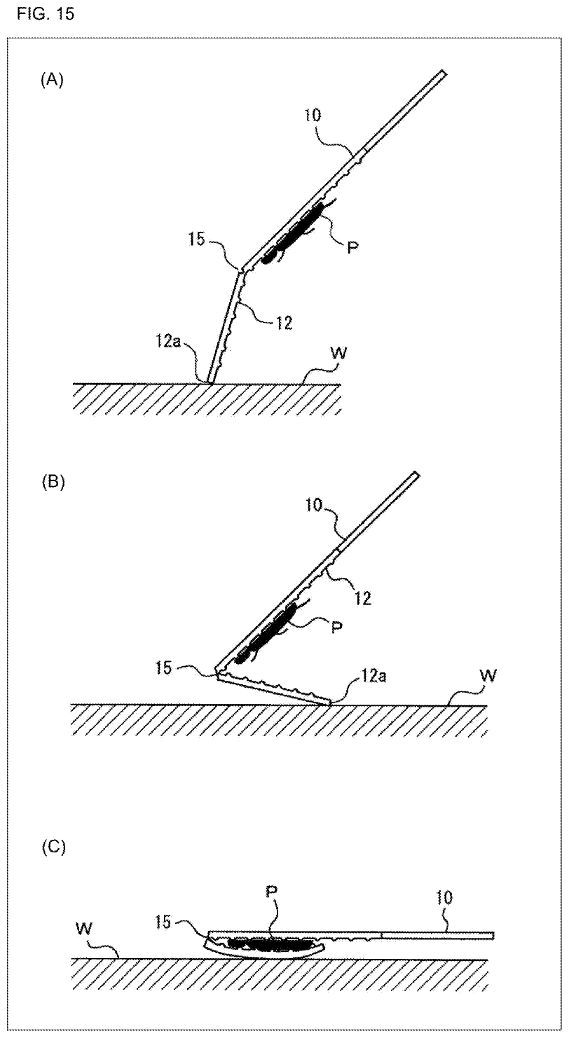

With the insect pest P captured on the adhesive surface 12 of the insect capturing sheet 100 as above, the grip 23 is operated to press the distal end of the insect capturing sheet 100 against the nearby floor W or another surface and move the insect capturing tool 20 forward substantially parallel to the floor W in the manner shown in FIG. 14. This allows the distal end portion of the sheet body 10 of the insect capturing sheet 100 to bend toward the adhesive surface 12 at the crease 15. The insect capturing tool 20 is further pressed against the floor W until the sheet body 10 is folded in two. As shown in FIG. 15, the insect pest P captured on the adhesive surface 12 is thus entirely wrapped in the distal end portion of the bent sheet body 10, completely captured inside the sheet body 10 without being viewable from outside.

When the insect capturing sheet 100 is folded in two by pressing the distal end of the insect capturing sheet 100 against the floor or wall W, the end adhesive layer 12b of the sheet body 10 is placed into contact with the floor W or another surface as shown in FIG. 15, thus facilitating reliable folding. More specifically, without the end adhesive layer 12b, the sheet body 10 having the distal end pressed against the floor W or another surface may slide on the floor surface and may not be folded easily. The end adhesive layer 12b at the distal end face can be caught on the floor W reliably, thus facilitating reliable wrapping of the insect pest P.

The insect capturing sheet 100 wrapping the captured insect pest P is then moved to, for example, over a garbage bin. The handle 22b of the clamp 22 is then depressed, causing the insect capturing sheet 100 wrapping the insect pest P to separate (drop) from the holding plate 21 into the garbage bin. In this manner, the insect capturing sheet 100 capturing an insect pest P can be disposed of in a clean and smooth manner, without causing exposure to or direct viewing of the captured insect pest P.

As described above, the insect capturing sheet 100 according to one embodiment of the present invention includes the net 11 on the adhesive layer 12a on the adhesive surface 12 of the sheet body 10. When the adhesive surface 12 of the sheet body 10 comes in contact with the floor or wall W, the net 11 reduces direct contact between the adhesive layer 12a and the floor or wall W, thus preventing the sheet body 10 from firmly adhering to the floor or wall W. Thus, no adhesive remains on the floor or wall W as a stain.

After capturing the insect pest P, the sheet body 10 can be easily folded in two along the crease 15. Thus, the captured insect pest P can be wrapped and disposed of smoothly. Also, when the sheet body 10 is folded in two to wrap the captured insect pest P for disposal, the end adhesive layer 12b is placed into contact with the floor or another surface to have the end adhesive layer 12b loosely adhering to the floor W. This facilitates reliable wrapping of the insect pest P.

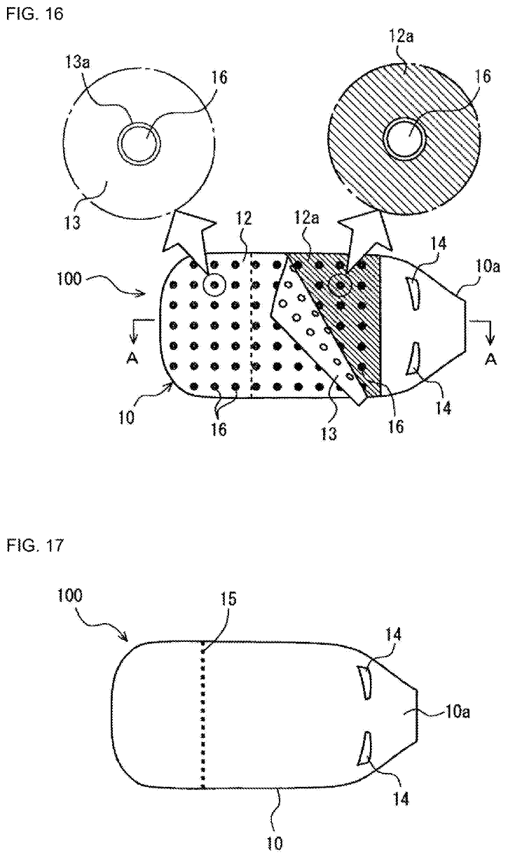

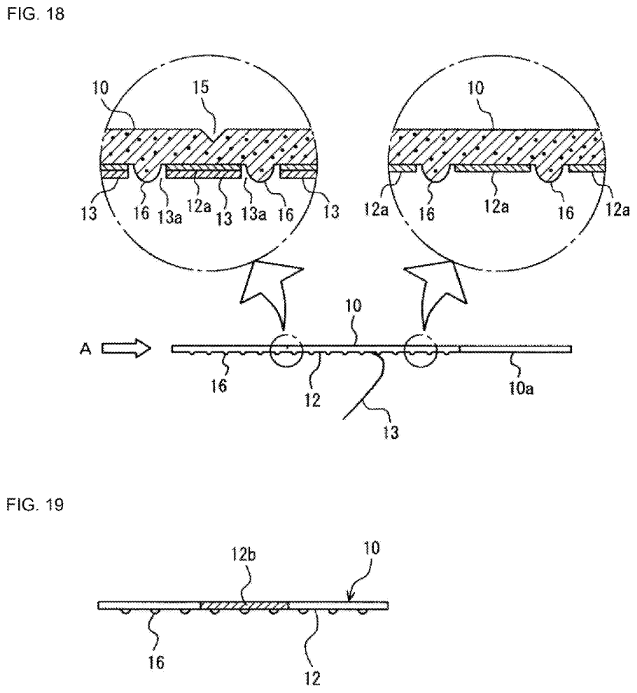

FIGS. 16 to 19 are views of an insect capturing sheet 100 according to another embodiment of the present invention. FIG. 16 is a front surface view, FIG. 17 is a back surface view, FIG. 18 is a cross-sectional view taken along line A-A in FIG. 16, and FIG. 19 is a front view in direction A in FIG. 18. As illustrated, the insect capturing sheet 100 according to the present embodiment includes a substantially rectangular, flexible sheet body 10 having an adhesive surface (front surface) 12 with a lattice of hemispherical protruding dots 16 arranged at equal intervals. An adhesive layer 12a is located on substantially the entire adhesive surface 12 excluding the portions where the protruding dots 16 are arranged.

A release liner 13 covers the adhesive layer 12a and can be peeled off with the adhesive layer 12a remaining on the sheet body 10. In the same manner as in the embodiment described above, the surface (back surface) opposite to the adhesive surface 12 includes no adhesive layer 12a or other layers, with the surface of the sheet body 10 directly exposed.

In the same manner as in the embodiment described above, the adhesive layer 12a on the sheet body 10 in the present embodiment is formed from a known rubber adhesive or acrylic adhesive, which is located on the entire surface of the sheet body 10 excluding the portions where the protruding dots 16 are arranged. In other words, as shown in FIG. 18, the adhesive layer 12a is not located in the portions where the protruding dots 16 are arranged on the adhesive surface 12. Thus, the release liner 13 covering the adhesive layer 12a has through-holes 13a at portions facing the protruding dots 16 to uncover the protruding dots 16.

The insect capturing sheet 100 according to the present embodiment with the above structure includes multiple protruding dots 16 uncovered with the adhesive layer 12a on the adhesive surface 12. The protruding dots 16 act in the same manner as the net 11 described above, allowing the insect capturing sheet 100 to avoid clinging to the floor W or another surface or the adhesive on the adhesive layer 12a to remain on the floor W or another surface as a stain. When failing to capture an insect pest P as well, the insect capturing sheet 100 can avoid having the adhesive surface 12 clinging to the floor W or another surface and can be peeled off easily.

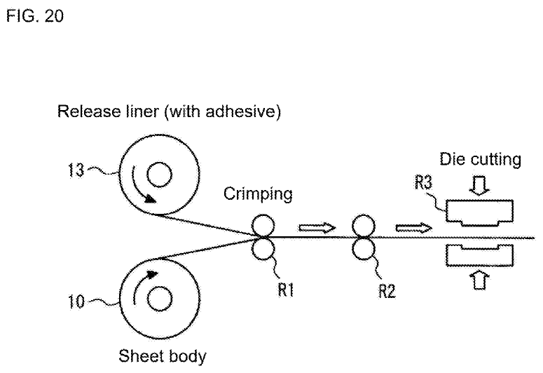

The insect capturing sheet 100 according to the present embodiment with the above structure may be manufactured easily with a process shown, but not limited to, for example, in FIG. 20. More specifically, a roll of release liner 13 with adhesive and pre-formed through-holes 13a for receiving the protruding dots 16 and a roll of sheet body 10 are fed to pressure rollers R1 and R2 in a synchronized manner to align the protruding dots 16 with the through-holes 13a in the release liner 13. With the adhesive surface of the release liner 13 facing the sheet body 10, the pressure rollers R1 and R2 crimp the aligned release liner 13 and the sheet body 10 together. A die cutter R3 then cuts the resultant sheet into the shape shown in FIG. 16. In this manner, the insect capturing sheet 100 may be manufactured continuously.

### REFERENCE SIGNS LIST

100 insect capturing sheet
10 sheet body
11 net
12 adhesive surface
12a adhesive layer
12b end adhesive layer
13 release liner
13a through-hole
15 crease
16 protruding dot
20 insect capturing tool
P insect pest
W floor or wall

1. An insect capturing sheet for covering and capturing an insect pest on a wall or floor, the sheet comprising:
a sheet body having an adhesive surface, the sheet body being flexible;
an adhesive layer on the adhesive surface of the sheet body; and
a net on the adhesive layer, the net including yarns having intersections including raised dots,
wherein the sheet body includes a crease along which the sheet body is foldable to have the adhesive surface inside, and
the sheet body has a curved end face including, substantially in a middle of the end face, an end adhesive layer continuous with or separate from the adhesive layer on the adhesive surface.

2. An insect capturing sheet comprising:
a flexible sheet body having an adhesive surface and a plurality of protrusions on the adhesive surface of the sheet body,
an adhesive layer on substantially an entirety of the adhesive surface excluding portions where the plurality of protrusions are arranged, and
a release liner entirely covering the adhesive layer.

3. An insect capturing tool for holding the insect capturing sheet according to claim 1, the tool comprising:
a holding plate to be on a back surface of the insect capturing sheet opposite to the adhesive surface;
a clamp configured to hold the insect capturing sheet on the holding plate; and
a grip extending from the holding plate.

4. The insect capturing sheet according to claim 1, wherein the sheet body includes an attachment hole.

5. An insect capturing tool for holding the insect capturing sheet according to claim 4, the tool comprising:
a holding plate to be on a back surface of the insect capturing sheet opposite to the adhesive surface;
a clamp configured to hold the insect capturing sheet on the holding plate; and
a grip extending from the holding plate.

6. The insect capturing tool according to claim 5, wherein
the grip includes a plurality of tubes arranged telescopically to one another.

7. An insect capturing tool for holding the insect capturing sheet according to claim 2, the tool comprising:
a holding plate to be on a back surface of the insect capturing sheet opposite to the adhesive surface;
a clamp configured to hold the insect capturing sheet on the holding plate; and
a grip extending from the holding plate.
